(19) United States
(12) Patent Application Publication
(10) Pub. No.: US 2016/0250750 A1
(43) Pub. Date: Sep. 1, 2016

(54) ROBOT CONTROL DEVICE FOR AUTOMATICALLY SWITCHING LIMITATION MODE ON OPERATION OF ROBOT

(71) Applicant: FANUC Corporation, Yamanashi (JP)

(72) Inventor: Teruki KUROSHITA, Yamanashi (JP)

(21) Appl. No.: 15/052,909

(22) Filed: Feb. 25, 2016

(30) Foreign Application Priority Data
Feb. 26, 2015 (JP) 2015-037229

(51) Int. Cl. B25J 9/16

(52) U.S. Cl. CPC B25J 9/1651; B25J 9/1674; B25J 9/1694; G05B 2219/43058

(57) ABSTRACT

A robot control device has the function of limiting the operation of a motor which drives a robot when a predetermined limiting condition is satisfied. The robot control device includes a judging part which judges whether or not the limiting condition is satisfied in accordance with performance results of operation of the robot, and a limiting part which imposes a limit an operation of the motor when the judging part judges that the limiting condition is satisfied.

### BACKGROUND OF THE INVENTION

1. Field of the Invention

The present invention relates to a robot control device which controls an industrial robot.

2. Description of the Related Art

In the general practice, after an operating program for a robot is prepared, a robot is subject of a test run, in order to check the content of the operating program. At this time, to ensure the safety of objects and workers around the robot, it is desirable to operate the robot at a low speed or low output.

According to the known art, the output of an axis is limited so as to improve the safety of objects and workers in the operating range of the robot. Japanese Patent Publication No. 2000-108065 discloses a scalar robot which is configured to be driven by a lower torque than the time of normal operation in accordance with a command from the user and to confirm the safety of the work. Japanese Patent Publication No. S62-166410 discloses a method of operating a robot which ensures that an output of a motor falls within a safe range during a process for checking a movement path of a tool which is taught to the robot.

Japanese Patent Publication No. 2014-176934 discloses a robot system which switches a motion mode so as to operate a robot with a lower output than a normal motion mode, depending on the situation around the robot. Japanese Patent Publication No. 2004-216504 discloses a robot control device which controls a loader for loading or unloading workpieces to and from a machine tool, in which the loader is operated at a lower speed than normal for a predetermined time period or a predetermined number of cycles upon activation.

Japanese Patent Publication No. 2009-142903 discloses a robot control device which is configured to use special parameters different from general parameters which are applied to general operation, when performing particular operation in a particular space which is designated within an operating space of the robot. According to the invention which is disclosed in Japanese Patent Publication No. 2009-142903, the special parameters are applied only when performing an operation which requires a higher precision, thereby realizing the required precision and maintaining the work efficiency at the same time.

In an existing system in which limitation modes on operation are automatically switched, either a normal mode in which a robot is operated with a normal output or a low output mode in which it is operated with a lower output is selectively applied. For this reason, at the time of performing a test run of a robot, even after safety has been confirmed for part of the operating program, the entire operating program is to be run according to the low output mode. This tends to increase the time required for the test run and decrease the efficiency. In a system which is configured so that an operator manually selects the limitation on operation, there is a risk of performing a test run according to the normal mode, even though the safety has yet to be actually confirmed. In a system which is configured so as to switch the limitation mode on operation, depending on the operating space, the test run may be performed according to the low output mode, even after the safety is confirmed.

Therefore, there is a need for a robot control device in which the robot is switched to the low speed mode or low output mode at a suitable timing, without relying on complicated additional equipment.

### SUMMARY OF THE INVENTION

According to a first aspect of the invention of the present application, there is provided a robot control device configured to impose a limit on an operation of at least one drive device which drives a robot when a predetermined limiting condition is satisfied, the robot control device comprising: a judging part configured to judge whether or not the limiting condition is satisfied in accordance with performance results of operation the robot; and a limiting part configured to impose a limit on an operation of the at least one drive device when the judging part judges that the limiting condition is satisfied.

According to a second aspect of the invention of the present application, there is provided a robot control device according to the first aspect wherein the robot control device is configured to control the robot in accordance with at least one operational instruction which is contained in an operating program, wherein the robot control device further comprises a counting part configured to count a number of times of execution of the at least one operational instruction, and wherein the judging part is configured to judge that the limiting condition is satisfied when the number of times of execution of the at least one operational instruction is equal to a predetermined first threshold value or less.

According to a third aspect of the invention of the present application, there is provided a robot control device according to the first aspect of the invention wherein the robot control device further comprises a counting part configured to count, when the robot is in operation, a number of times of entry of the robot enters into each of a plurality of sub-regions which are formed by dividing an operating space of the robot, wherein the judging part is configured to judge that the limiting condition is satisfied when the number of times of entry is equal to a predetermined second threshold value or less.

According to a fourth aspect of the invention of the present application, there is provided a robot control device according to any one of the first to third aspects wherein the limiting part is configured to impose a limit on a torque command value to the at least one drive device to a predetermined range, when the limiting condition is satisfied.

According to a fifth aspect of the invention of the present application, there is provided a robot control device according to any one of the first to fourth aspects wherein the robot control device further comprises: a force detecting part configured to detect an external force which is applied to the robot; and an operation terminating part configured to terminate operation of the robot when the external force which is detected by the force detecting part exceeds a predetermined third threshold value, wherein the limiting part is configured to replace the third threshold value with a fourth threshold value which is smaller than the third threshold value when the limiting condition is satisfied.

According to a sixth aspect of the invention of the present application, there is provided a robot control device according to any one of the first to fifth aspects wherein the at least one drive device is configured to be controlled in accordance with feedback control, based on a detected value of at least one of a position and speed, and wherein the limiting part is configured to reduce at least one of a position loop gain and speed loop gain which are used in feedback control of the drive device when the limiting condition is satisfied.

According to a seventh aspect of the invention of the present application, there is provided a robot control device according to any one of the first to sixth aspects wherein the limiting part is configured to impose a limit on the speed of the at least one drive device when the limiting condition is satisfied.

According to an eighth aspect of the invention of the present application, there is provided a robot control device according to the second aspect wherein the robot control device further comprises a resetting part configured to reset the number of times of execution to an initial value when the operating program is changed.

These and other objects, features and advantages of the present invention will become more apparent in light of the detailed description of exemplary embodiments thereof as illustrated in the drawings.

### BRIEF DESCRIPTION OF THE DRAWINGS

FIG. 1 shows an exemplary configuration of a robot control device according to one embodiment.

FIG. 2 is a functional block diagram of a servo circuit of a robot control device.

FIG. 3 is a functional block diagram of a robot control device according to one embodiment.

FIG. 4 is a flow chart for performing a test run of a robot by using a robot control device according to one embodiment.

FIG. 5 shows an example of an image which is displayed on a display of a teaching pendant when setting a limiting target.

FIG. 6 shows an example of an image which is displayed on a display of a teaching pendant when applying a speed limit to a motor.

FIG. 7 shows an example of an image which is displayed on a display of a teaching pendant when setting the contents of limiting conditions.

FIG. 8 is a flow chart for performing processes which are run by a robot control device during a test run of a robot.

FIG. 9 shows an example of sub-regions which are formed by dividing an operating space of a robot.

FIG. 10 shows an example of an image which is displayed on a display of a teaching pendant when setting limiting conditions.

FIG. 11 is a flow chart for performing processes which are repeatedly run by a predetermined control period in a robot control device according to a second embodiment.

FIG. 12 is a functional block diagram of a robot control device according to a modification of the first embodiment.

### DESCRIPTION OF EMBODIMENTS

Embodiments of the present invention will be described with reference to the accompanying drawings. The constituent elements of the illustrated embodiments are modified in scale as necessary to facilitate understanding of the present invention. The same or corresponding constituent elements are assigned the same reference notations.

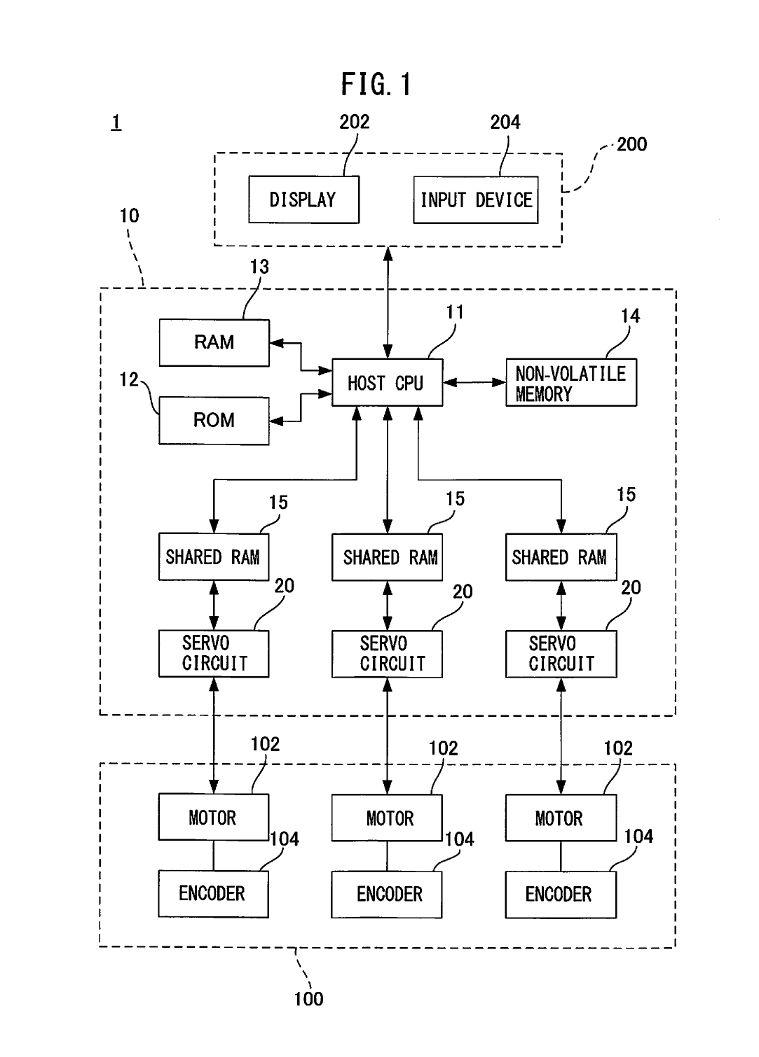

FIG. 1 shows an exemplary configuration of a robot system 1 which includes a robot control device 10 according to one embodiment. The robot system 1 includes a robot control device 10, a robot 100 which is controlled by the robot control device 10, and a teaching pendant 200 which is connected to the robot control device 10. The robot 100 is a multiple-joint robot which has any known configuration. Referring to FIG. 1, for simplification, only motors 102 which act as drive devices for driving joints of the robot 100, and encoders 104 for detecting rotational positions, rotational speeds, etc. of the motors 102 are illustrated.

The teaching pendant 200 is provided with a known display 202 such as a liquid crystal display and a known input device 204 such as a keyboard. The display 202 may be a touch panel which also has the function as an input means. The input device 204 is used to input and edit of data and parameters. The input device 204 may also be used to manually input commands to a robot, when performing manual feed processing.

The robot control device 10 is provided with a host CPU 11 which controls the robot control device 10 as a whole, a ROM 12 which stores various system programs, a RAM 13 which temporarily stores data such as results of computation of the host CPU 11, and a non-volatile memory 14 which stores various programs such as an operating program for a robot and parameters related to these programs.

As shown in FIG. 1, a plurality of shared RAMs 15 are connected to the host CPU 11. The shared RAMs 15 are connected to servo circuits 20.

The shared RAMs 15 receive commands and other control signals from the host CPU 11 and output them to the servo circuits 20. Further, the shared RAMs 15 receive various signals from the servo circuits 20 and output them to the host CPU 11. Although not illustrated, the servo circuits 20 each have hardware configurations including CPUs, ROMs, RAMs, etc.

In FIG. 1, only three shared RAMs 15 and three servo circuits 20 are illustrated for simplification, but the same numbers of shared RAMs 15 and servo circuits 20 as the joints of the robot 100 may be provided. That is, if the robot 100 is a vertical multiple-joint robot with six joints, six shared RAMs 15, six servo circuits 20, six motors 102, and six encoders 104 are provided.

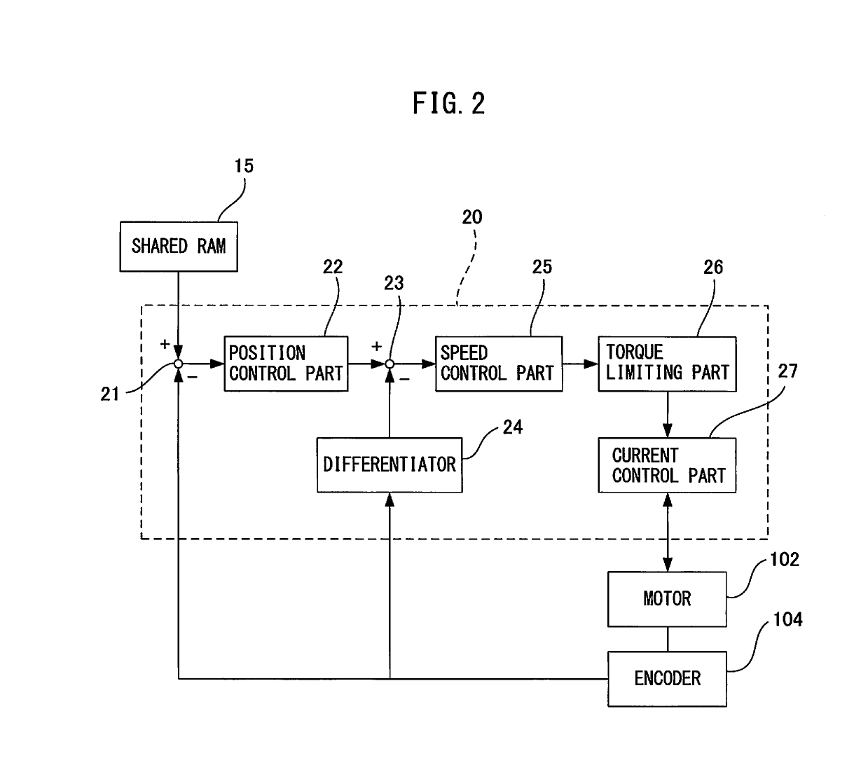

FIG. 2 is a functional block diagram of a servo circuit 20. The servo circuit 20 is a digital circuit which is provided with a first subtractor 21, position control part 22, second subtractor 23, differentiator 24, speed control part 25, torque limiting part 26, and current control part 27.

The first subtractor 21 subtracts the detected position of the motor 102 from the target position of the motor 102 which is included in a position command. The position command is generated by the host CPU 11 (see FIG. 1) in accordance with the operating program. The position command is input through the shared RAM 15 to the first subtractor 21 of the servo circuit 20. The detected position of the motor 102 is acquired by the encoder 104. The amount of position deviation is calculated by the first subtractor 21 and is input to the position control part 22.

The position control part 22 multiplies the amount of position deviation which is calculated by the first subtractor 21 with a predetermined position loop gain to obtain a speed command. The speed command which is obtained by the position control part 22 is input to the second subtractor 23.

The second subtractor 23 subtracts the detected speed of the motor 102 from the speed command which is calculated by the position control part 22. The detected speed of the motor 102 is found by differentiating the detected positions which are acquired by the encoder 104 by the differentiator 24. The amount of speed deviation which is calculated by the second subtractor 23 is input to the speed control part 25.

The speed control part 25 multiplies the amount of speed deviation which is calculated by the second subtractor 23 with a predetermined speed loop gain to obtain a torque command. The torque command which is obtained by the speed control part 25 is input through the torque limiting part 26 to the current control part 27.

The torque limiting part 26 is provided for the purpose of protecting the motor 102. For example, in order to prevent an electric current greater than the maximum current which is set for the motor 102 from being applied to the motor, the torque limiting part 26 has the function of clamping the torque command at a value corresponding to the maximum current. However, the functions of the torque limiting part 26 are not limited to the ones explained above. The torque limiting part 26 may also be configured to clamp the torque value at a certain predetermined upper limit value or lower limit value.

The current control part 27 generates a current command for driving the motor 102 in accordance with a torque command which is input through the torque limiting part 26. The motor 102 is driven in response to the current which is applied according to the current command from the current control part 27.

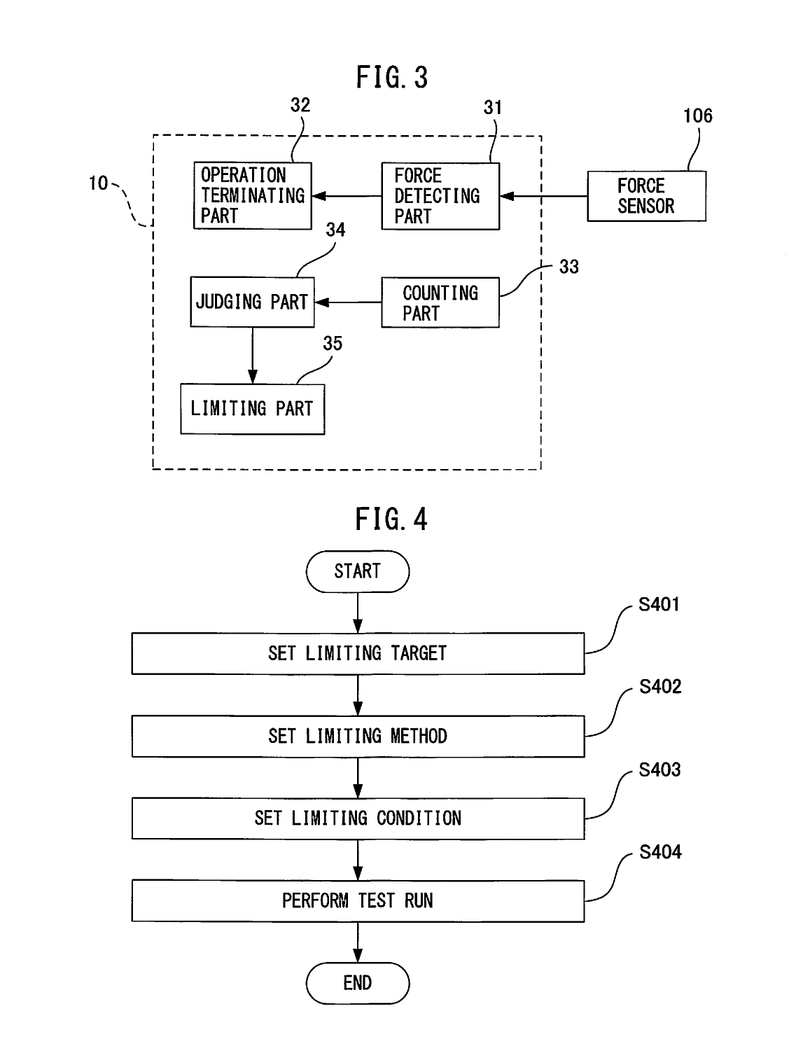

FIG. 3 is a functional block diagram of a robot control device 10 according to one embodiment. The robot control device 10 is provided with a force detecting part 31, operation terminating part 32, counting part 33, judging part 34, and limiting part 35.

The force detecting part 31 detects external force which acts on the robot 100 in cooperation with a force sensor 106. The force sensor 106 may be, for example, provided at each joint of the robot 100. The force detecting part 31 acquires the force which acts on a joint to which the force sensor 106 is attached. The operation terminating part 32 terminates the operation of the robot 100 by the host CPU 11 or servo circuit 20 when the force which is detected by the force detecting part 31 exceeds a predetermined threshold value.

The counting part 33 has the function of collecting the operating results of the robot 100 when carrying out a test run of the robot 100. In one embodiment, the counting part 33 counts the number of times of execution of at least one operational instruction which is included in the operating program.

The judging part 34 compares the operating results of the robot 100 from the counting part 33, for example, the number of times of execution of the operational instruction, with a predetermined threshold value, to judge whether or not the limiting condition is satisfied, or in other words, whether or not the operation of the motor 102 should be limited.

The limiting part 35 limits the operation of the motor 102 if the judging part 34 judges that the operation of the motor 102 should be limited. For example, the limiting part 35 limits the output of the motor 102 and switches the limitation mode on operation of the robot 100 to operate it according to the low output mode. Alternatively, the limiting part 35 limits the speed of the motor 102 and switches the limitation mode on operation of the robot 100 to operate it according to the low speed mode.

FIG. 4 is a flow chart for performing a test run of the robot 100 by using a robot control device 10 according to one embodiment. Steps S401 to S403 are preparatory processes which are performed before the test run. At step S401, a limiting target to be limited for ensuring the safety of the test run is set. According to one embodiment, the output of the motor 102 may be limited. According to another embodiment, the rotational speed of the motor 102 may be limited.

At step S402, the limitation method is set. According to one embodiment, the position loop gain or speed loop gain which is used in the feedback control of the motor 102 may be reduced. According to another embodiment, a torque command value for the motor 102 is limited so as to be included in a predetermined range between a predetermined upper limit value and lower limit value.

At step S403, the limiting condition is set. According to one embodiment, when the number of times of execution of the same operational instruction which is included in an operating program is a predetermined threshold value or less, a limit is imposed on the operation of the motor 102 when executing the operational instruction.

After the preparatory process of steps S401 to S403 is completed, the process proceeds to step S404 where the test run of the robot 100 is performed. It should be noted that the order of execution of step S401 to step S403 is not limited to the illustrated example. The test run of the robot 100 is conducted according to the operating program. Alternatively, the operator may successively give commands to the robot 100 through a manual feed processing using the teaching pendant 200 to conduct a test run of the robot 100.

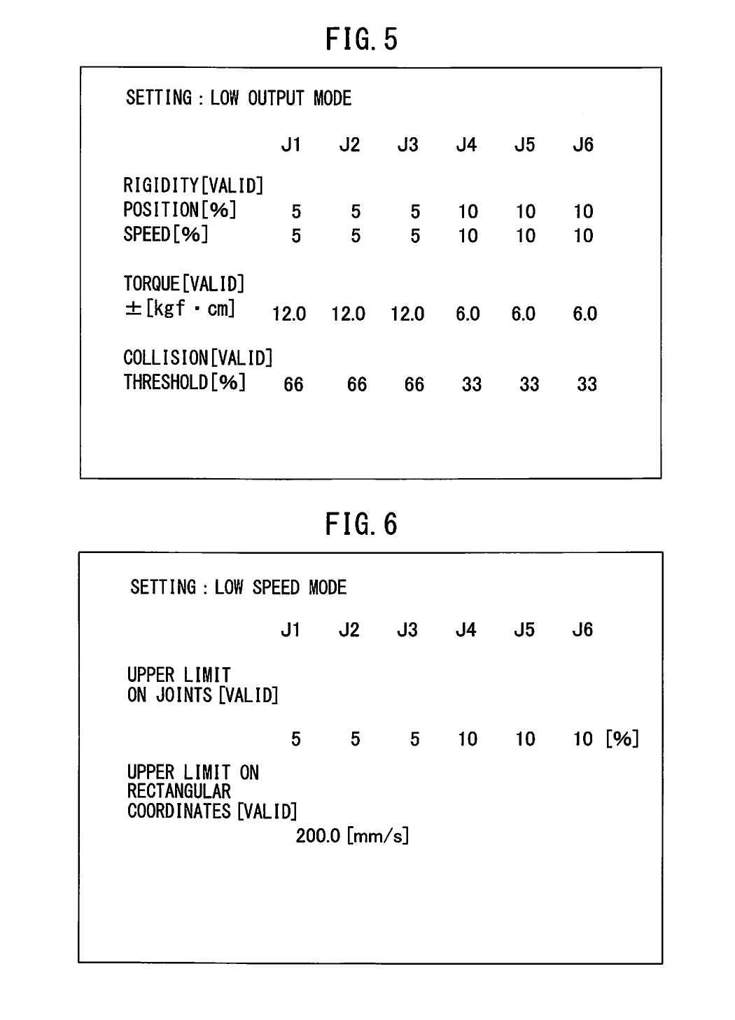

Referring to FIG. 5, the process of step S401 of FIG. 4 will be explained in detail. FIG. 5 shows an example of an image which is displayed on the display 202 of the teaching pendant 200 when setting the limiting target. In this example, the screen when limiting the output of the motor 102 is shown. According to one embodiment, the limits on the six joints J1 to J6 can be switched to validate or invalidate all at once. However, the limits may also be validated or invalidated individually for the joints J1 to J6. In the illustrated example, the teaching pendant 200 is configured so as to allow the parameters to be individually set for the joints J1 to J6.

As shown in FIG. 5, the respective items, or “rigidity”, “torque”, and “collision,” are set to “valid.” Therefore, in the illustrated example, the limits corresponding to the respective fields are set to valid.

The field of “rigidity” is used for changing the position loop gain which is used in the position control part 22 or the speed loop gain which is used in the speed control part 25. According to one embodiment, the position loop gain and the speed loop gain on which the output limits are imposed is indicated on percentage relative to the position loop gain and the speed loop gain to which no output limits are imposed. The thus set position loop gain and speed loop gain are stored in the non-volatile memory 14 (see FIG. 1).

The magnitude of the speed command which is generated by the position control part 22 and the magnitude of the torque command which is generated by the speed control part 25 are respectively proportional to the position loop gain and the speed loop gain. For this reason, if the position loop gain or the speed loop gain is set to be small, the output of the motor 102 is decreased. Therefore, even if the robot 100 comes in contact with a surrounding object or worker during operation, the force which is imparted from the robot 100 to the object or worker falls and a serious accident can be prevented from happening.

In the field of “torque” which is shown in FIG. 5, the upper limit values and lower limit values of the torques to be imparted to the joints J1 to J6 are set.

That is, the tolerances of the torques of the joints J1 to J6 can be input in the field. Specifically, when the torque limit is valid, the torques of the joints J1 to J6 are limited to the range of the “torque at time of start±tolerance (input value).” The “torque at time of start” is the torque which acts against the gravity which acts on the robot 100 and is necessary to support the robot 100. The upper limit value and lower limit value for the torque limit are stored in the non-volatile memory 14. In this way, by clamping the torques of the joints J1 to J6 in accordance with the upper limit value or lower limit value, even if the robot 100 comes in contact with a surrounding object or worker, the force which is applied from the robot 100 to an object or worker falls, and a serious accident can be prevented from happening.

The field of “collision” is used for setting the threshold value which is used for comparison with the force which is detected by the force detecting part 31 in the operation terminating part 32. The operation terminating part 32 terminates the operation of the robot 100 when the force detection value exceeds a threshold value, regardless of whether the output limit or speed limit of the motor 102 is valid or invalid. The input value which is shown in FIG. 5 corresponds to the threshold value which should be used when the output limit is valid on percentage relative to a reference threshold value which is used when the output limit is invalid. By setting the threshold value for the judgment of collision to be small in this way, it is possible to stop the robot 100 quickly when the robot 100 comes in contact with a surrounding object or worker. Therefore, it is possible to prevent serious accidents from happening.

FIG. 6 shows an example of an image which is displayed on the display 202 of the teaching pendant 200 when imposing a speed limit to the motor 102. In this example, the validity and the invalidity of the speed limit are switched to each other all at once for all of the joints J1 to J6. In the field of “upper limit of joints,” the upper limit value of the speeds of the joints J1 to J6 can be input, on percentage relative to the maximum speed. Further, in the field of “upper limit of rectangular coordinates,” an upper limit value of the speed in the rectangular coordinate system of the end effector of the robot 100 can be input.

When the speed limit is valid, it is more likely to discover that the robot 100 is coming in contact with a surrounding object or worker before actual contact. The speed limit may be imposed by, for example, changing the position command which is output from the host CPU 11 to the servo circuit 20. Specifically, if the speed which is obtained by differentiating the target positions which is contained in the position command exceeds the upper limit value, the target position may be changed in accordance with the speed clamped to the upper limit value.

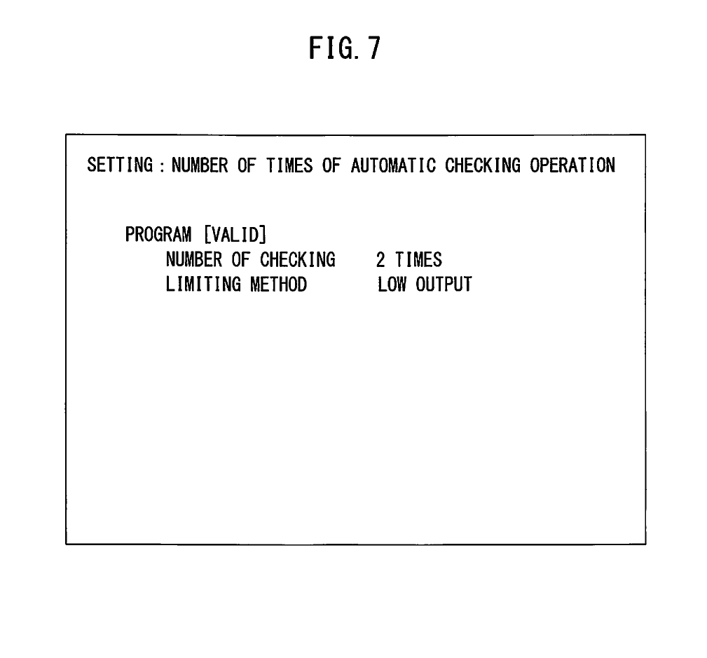

Referring to FIG. 7, the process of step S403 of FIG. 4 will be explained in further detail. FIG. 7 shows an example of an image which is displayed on the display 202 of the teaching pendant 200 when setting the contents of the limiting conditions. In the field of “number of times of checking,” how many times (threshold value) the output limit or the speed limit should be imposed when executing the operating program. In the field of “Limiting method”, either the “low output mode” or “low speed mode” is selected.

In the illustrated example, the test run is performed according to the “low output mode” until an operational instruction of the operating program is executed two times. On the other hand, when a certain operational instruction is executed three times or more, the operational instruction is executed in the normal mode where no limits are imposed. According to one embodiment, a common threshold value is set for all of the operational instructions of the operating program, but threshold values may also be individually set for each operational instruction as necessary.

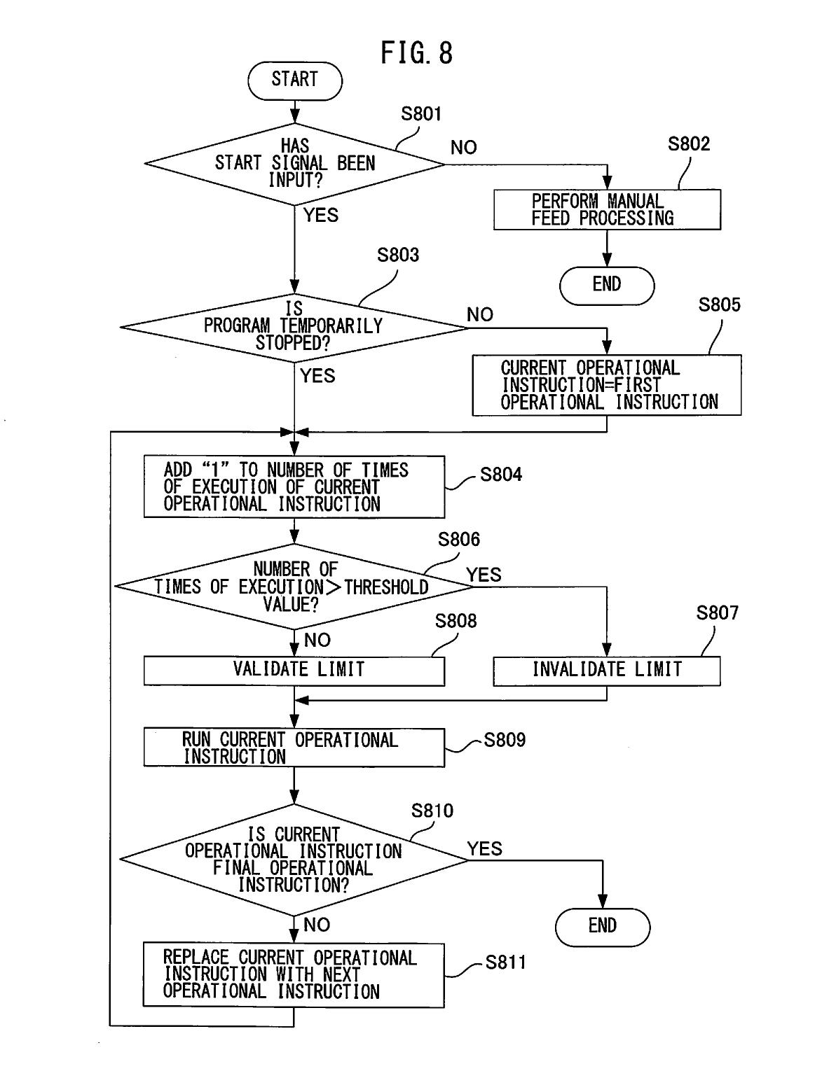

Referring to FIG. 8, the process of step S404 of FIG. 4 will be explained. FIG. 8 is a flow chart of a process which is executed by the robot control device 10 when performing a test run of the robot 100. The test run of the robot 100 is automatically performed when a start signal is input so as to operate the robot 100 in accordance with an operating program which contains at least one operational instruction.

The robot control device 10 monitors the input of a start signal. At step S801, it is judged whether or not a start signal has been input. If no start signal has been input (if the result of the judgment at step S801 is negative), the process proceeds to step S802 where manual feed processing is performed and the robot 100 is controlled to execute a command which is input using the input device 204 of the teaching pendant 200. On the other hand, when a start signal is input (when the result of the judgment of step S801 is positive), the process proceeds to step S803 where it is judged whether or not the operating program is temporarily stopped.

If it is judged that the operating program is temporarily stopped (when the result of the judgment at step S803 is positive), the process proceeds to step S804 where the counting part 33 adds “1” to the number of times of execution of the current operational instruction. On the other hand, if the result of the judgment at step S803 is negative, the process proceeds to step S805 where the first operational instruction of the operating program is set to the current operational instruction.

At step S806, the judging part 34 judges whether or not the number of times of execution of the current operational instruction has exceeded a predetermined threshold value. If it is judged that the number of times of execution has exceeded the threshold value (when the result of the judgment at step S806 is positive), the limit on the motor 102 is invalidated at step S807 and the process proceeds further to step S809 where the current operational instruction is executed.

On the other hand, if it is judged that the number of times of execution is equal to the threshold value or less (if the result of the judgment at step S806 is negative), the limit on the motor 102 is validated at step S808, and then the current operational instruction is executed.

At step S810, it is judged whether or not the current operational instruction is the final operational instruction of the operating program. If the result of the judgment at step S810 is positive, the process of checking safety of the operating program is ended. On the other hand, if the result of the judgment at step S810 is negative, the process proceeds to step S811 where the current operational instruction is replaced with the next operational instruction. Then, the process returns to step S805 and steps S806 to S810 are repeated for the next operational instruction.

According to a robot control device according to the present embodiment, the following effects can be achieved:

(1) In according with the number of times of execution of an individual operational instruction which is contained in an operating program, the limitation mode on operation is switched to the low output or low speed mode to execute the operational instruction. If the number of times of execution of a certain operational instruction is few and it is assumed that the safety of the operational instruction is not confirmed, the operational instruction is executed with a low output or at a low speed. Therefore, it is possible to ensure the safety of objects or workers around the robot, while performing a test run as necessary.

(2) Switching to the low output mode or low speed mode is automatically implemented in accordance with the number of times of execution of the operational instruction. There is no need for an operator to manually switch the limitation mode on operating, and therefore it is possible to prevent operational mistakes from happening and improve the work efficiency.

(3) Additional equipment for switching the limitation mode on operation to the low output mode or low speed mode is not required. Therefore, an inexpensive robot control device can be provided.

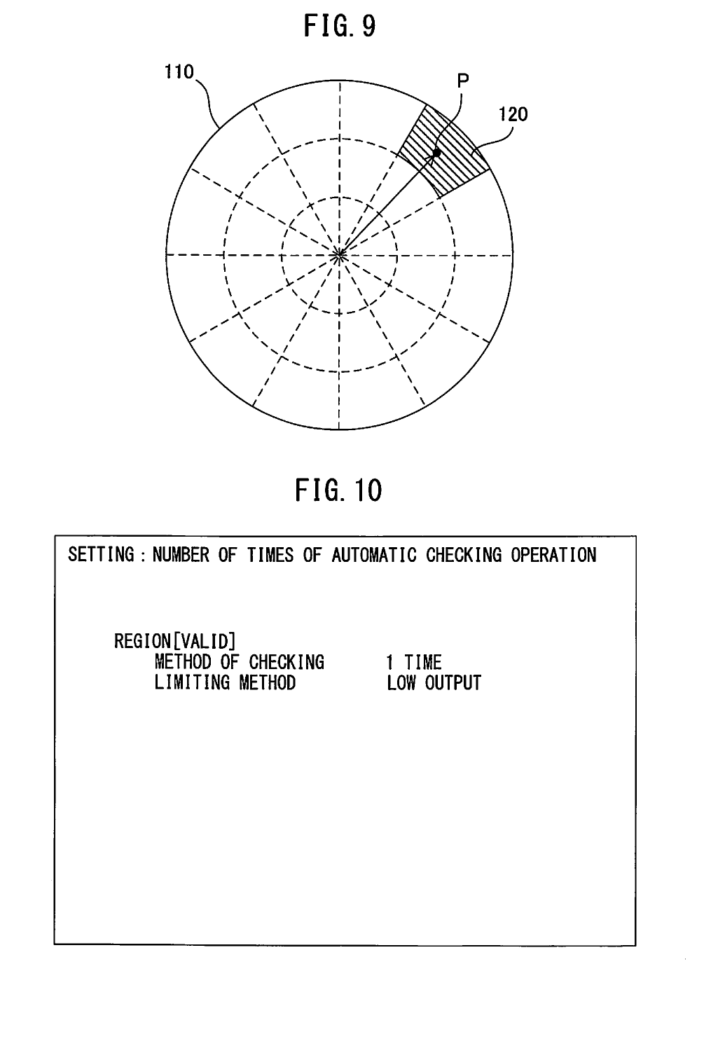

Referring to FIG. 9 to FIG. 11, a robot control device 10 according to a second embodiment will be explained. According to the present embodiment, it is determined whether or not the operation of the motor 102 is limited, depending on the number of times of entry into sub-regions which are formed by dividing the operating space of the robot 100.

FIG. 9 shows an example of the sub-regions which are formed by dividing the operating space 110 of the robot 100. In the figure, the solid line circle shows the operating space 110 of the robot 100. Specifically, the path of the end effector of the robot 110 when having the maximum stroke is shown as a circle. In one embodiment, the operating space 110 is divided into three sections at equal intervals from the center of the circle toward the outside in radial direction and is divided into twelve sections at every 30 degrees about the center. In this way, the operating space 110 is divided into 36 sub-regions.

As illustrated, the position P of the end effector is included in a certain sub-region 120. The counting part 33 (see FIG. 3) counts the number of times of entry of an end effector to the sub-region 120. The number of times of entry is stored in a non-volatile memory 14 (see FIG. 1).

The host CPU 11 of the robot control device 10 (see FIG. 1) refers to known geometrical information of the robot components and acquires the position P of the end effector from the current position of the motor 102 of each joint. The host CPU 11 can identify the sub-region 120 where the end effector is situated, from the position P of the end effector. In the illustrated example, the operating space 110 is divided into sub-regions in two-dimensional space by way of example, but a three-dimensional space may also be similarly divided into a plurality of sub-regions.

FIG. 10 shows an example of an image which is displayed on a display 202 of the teaching pendant 200 when setting limiting conditions in the present embodiment. In the illustrated example, “1” is input as the threshold value which is used in the judgment process by the judging part 34. Accordingly, if the number of times of entry into the sub-region 120 is 0 or 1, a limit is imposed on the operation of the motor 102.

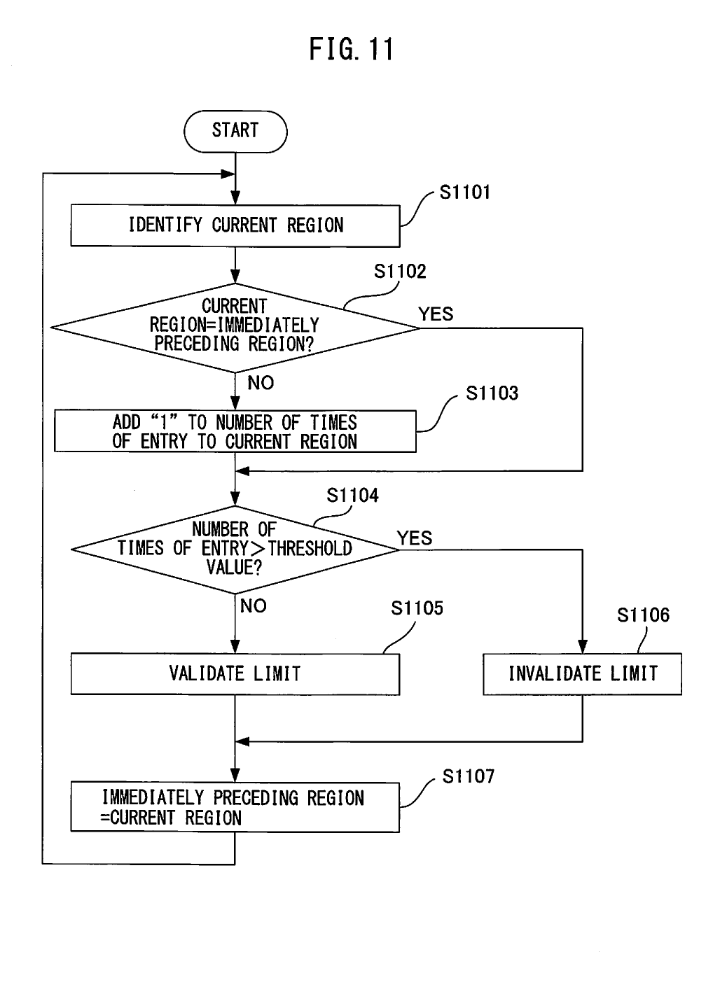

FIG. 11 is a flow chart for performing processes which are repeatedly run by a predetermined control period in the robot control device 10 according to the second embodiment.

At step S1101, the current region (sub-region 120) where the end effector of the robot 100 is situated is identified. The position P of the end effector, as described above, is calculated by the host CPU 11 based on the current position of the motor 102 which is detected by the encoder 104 and the geometric information of the robot components.

At step S1102, it is judged whether or not the current region which is found at step S1101 matches the immediately preceding region which is specified at step S1101 in the previous control period. If the current region does not match the immediately preceding region (if the result of the judgment at step S1102 is negative), the process proceeds to step S1103 where the counting part 33 adds “1” to the number of times of entry into the current region. On the other hand, when the current region matches the immediately preceding region (when the result of the judgment at step S1102 is positive), the process bypasses step S1103 and proceeds to step S1104. If step S1102 is executed for the first time, the result of the judgment at step S1102 is always positive and the process proceeds to step S1103.

At step S1104, the judging part 34 judges whether or not the number of times of entry into the current region has exceeded a predetermined threshold value. For example, as described above with reference to FIG. 10, when the threshold value is set to “1”, if the number of times of entry into the current region is two or more, the result of the judgment at step 1104 is positive.

If the number of times of entry into the current region is equal to the threshold value or less (if the result of the judgment at step S1104 is negative), the process proceeds to step S1105 where a preset limit on the motor 102 is validated. On the other hand, if the result of the judgment at step S1104 is positive, the process proceeds to step S1106 where the limit on the motor 102 is invalidated.

At step S1107, the “immediately preceding region” which is used for the judgment at step S1102 in the next control period is replaced with the “current region” which is identified at step S1101. Steps S1101 to S1107 are repeatedly executed until the robot 100 completes a series of processing which is determined by the operating program.

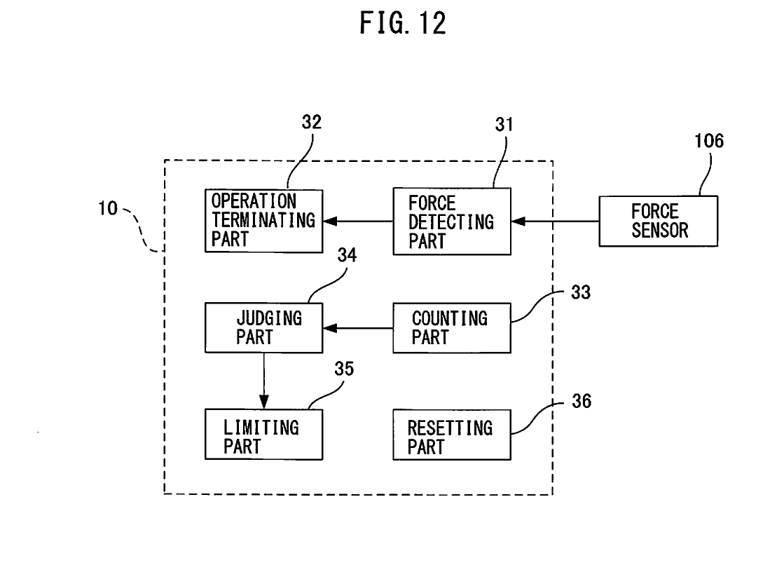

FIG. 12 is a functional block diagram of a robot control device 10 according to a modification of the above-mentioned first embodiment. The robot control device 10 according to the present modification further includes a resetting part 36 which resets the number of times of execution of operational instruction which is stored in the non-volatile memory 14. For example, if a change is made to an operating program to affect the contents of the operational instruction, the number of times of execution of the operational instruction under influence is reset to zero, thereby ensuring the safety of the operating program after change.

### Effect of the Invention

According to a robot control device according to the present invention, when running an operating program, the limitation mode on operation is automatically switched to a low speed or low output for at least part of the operating program, depending on the performance results of the operation. Therefore, it is possible to limit the operation of the robot at a suitable timing as necessary, without relying on any complicated additional equipment. This ensures the safety of objects and workers around the robot, while maintaining the work efficiency.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

1. A robot control device configured to impose a limit on an operation of at least one drive device which drives a robot when a predetermined limiting condition is satisfied, the robot control device comprising:
a judging part configured to judge whether or not the limiting condition is satisfied in accordance with performance results of operation of the robot; and
a limiting part configured to impose a limit on an operation of the at least one drive device when the judging part judges that the limiting condition is satisfied.

2. The robot control device according to claim 1, wherein the robot control device is configured to control the robot in accordance with at least one operational instruction which is contained in an operating program,
wherein the robot control device further comprises a counting part configured to count a number of times of execution of the at least one operational instruction, and
wherein the judging part is configured to judge that the limiting condition is satisfied when the number of times of execution of the at least one operational instruction is equal to a predetermined first threshold value or less.

3. The robot control device according to claim 1, further comprising a counting part configured to count, when the robot is in operation, a number of times of entry of the robot which enters into each of a plurality of sub-regions which are formed by dividing an operating space of the robot,
wherein the judging part is configured to judge that the limiting condition is satisfied when the number of times of entry is equal to a predetermined second threshold value or less.

4. The robot control device according to claim 1, wherein the limiting part is configured to impose a limit on a torque command value to the at least one drive device to a predetermined range, when the limiting condition is satisfied.

5. The robot control device according to claim 1, further comprising:
a force detecting part configured to detect an external force which is applied to the robot; and
an operation terminating part configured to terminate operation of the robot when the external force which is detected by the force detecting part exceeds a predetermined third threshold value,
wherein the limiting part is configured to replace the third threshold value with a fourth threshold value which is smaller than the third threshold value when the limiting condition is satisfied.

6. The robot control device according to claim 1, wherein the at least one drive device is configured to be controlled in accordance with feedback control, based on a detected value of at least one of a position and speed, and
wherein the limiting part is configured to reduce at least one of a position loop gain and speed loop gain which are used in feedback control of the drive device when the limiting condition is satisfied.

7. The robot control device according to claim 1, wherein the limiting part is configured to impose a limit on the speed of the at least one drive device when the limiting condition is satisfied.

8. The robot control device according to claim 2, further comprising a resetting part configured to reset the number of times of execution to an initial value when the operating program is changed.
